(19) United States
(12) Patent Application Publication
(10) Pub. No.: US 2025/0200923 A1
(43) Pub. Date: Jun. 19, 2025

(54) SWITCHING PLATES IN AN OPTICAL SYSTEM

(71) Applicant: HID Global Corp., Austin, TX (US)

(72) Inventor: Daniel Henri Raguin, Jupiter, FL (US)

(21) Appl. No.: 18/541,718

(22) Filed: Dec. 15, 2023

(51) Int. Cl. G06V 10/147; G06V 40/13

(52) U.S. Cl. CPC G06V 10/147; G06V 40/1324

(57) ABSTRACT

Techniques for increasing the depth of focus in an optical system are described. The optical system may be incorporated in a fingerprint scanner. The techniques described herein incorporate one or more switching plates in the optical system to selectively change the depth of focus. Although the switching plates may not have optical power, they can change object plane focal point of the optical system.

### TECHNICAL FIELD

The present disclosure generally relates to increasing depth of focus in optical systems, in particular, optical systems in fingerprint scanners.

### BACKGROUND

Some fingerprint scanners can include a replaceable field-option silicone membrane. Hence, fingerprint scanners can operate in the field with or without the silicone membrane. When the silicone membrane is used, the contrast and ability to capture dry fingerprints can be significantly improved. The membrane-optional scanning feature requires the fingerprint scanner to have a large enough depth of focus to allow for good imaging quality when the fingerprint is sitting on a silicone membrane as well as when it is sitting on the prism platen for the use-case where the silicone membrane is removed. A large depth of focus may also be required if the fingerprint scanner or other optical system drifts focus across its temperature range. A large depth of focus may also be desired to increase the speed with which a system may be focused.

### SUMMARY

This disclosure describes an optical system including an object plane to receive an object to be imaged, a lens to direct light beams from the object plane, and a sensor to convert the directed light beams into an image. The optical system also includes a plurality of switching plates being configured to be selectively inserted into an optical path between the object plane and the sensor defining different optical path lengths to account for changes in a location of the object plane.

This disclosure also describes a skin topology scanning system including a platen surface to receive at least one object having a skin topology, a lens to direct light beams from the platen surface, and a sensor to convert the directed light beams into an image of the at least one object. The skin topology scanning system also includes a plurality of switching plates being configured to be selectively inserted into an optical path between the platen surface and the sensor defining different optical path lengths to account for shifts in a location of the platen surface.

This disclosure further describes a method comprising: detecting an object having a skin topology being placed on a surface of a skin topology scanner; positioning a first switching plate of a plurality of switching plates in an optical path of the fingerprint scanner defining a first optical path length; capturing a first image of the skin topology of the object with the first optical path length; positioning a second switching plate of the plurality of switching plates in the optical path of the skin topology scanner defining a second optical path length; capturing a second image of the skin topology of the object with the second optical path; selecting the first image or the second image based on focus quality; and processing the selected image.

### BRIEF DESCRIPTION OF THE DRAWINGS

Various ones of the appended drawings merely illustrate example embodiments of the present disclosure and should not be considered as limiting its scope.

FIG. 1 illustrates example portions of an optical system.

FIG. 2A illustrates example portions of an optical system with an object plane at a first location.

FIG. 2B illustrates example portions of an optical system with an object plane at a second location.

FIG. 3 illustrates example portions of an optical system.

FIG. 4 illustrates example portions of an optical system for a fingerprint scanner.

FIG. 5A illustrates a blowup of region A marked in FIG. 4 for the case where no membrane is placed on the prism.

FIG. 5B is a blowup of region A for the case where a membrane is placed on the prism.

FIG. 6 illustrates example portions of a motor system.

FIG. 7 illustrates a flow diagram of a method for system configuration for a fingerprint scanner.

FIG. 8 illustrates a flow diagram of a method for operating a fingerprint scanner with insertable switching plates.

FIG. 9 illustrates a block diagram schematic of various example components of an example machine that can be used as, for example, a fingerprint scanning system.

### DETAILED DESCRIPTION

Techniques for increasing the depth of focus in an optical system are described. The optical system may be incorporated in a skin topology scanner, such as fingerprint scanner. The techniques described herein incorporate one or more switching plates in the optical system to selectively change the depth of focus. Although the switching plates may not have optical power, they can change object plane focal point of the optical system. The switching plates can switch in and out of the optical path of the optical system to change the optical path length (OPL) of the imaging system and thereby change the object plane location that achieves optimal focus at the fixed sensor (image plane) location.

The techniques described herein can be used for scanning skin topology of different objects, such as fingers, thumbs, palms, feet, etc. For the interest of clarity and brevity, finger or fingerprint, as used herein, is a general term for body part (object) having skin and fingerprint is general term for skin topology.

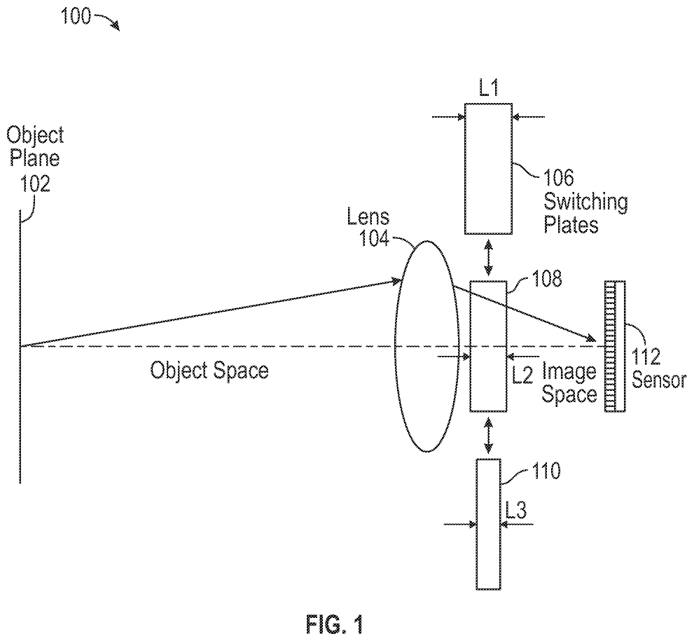

FIG. 1 illustrates example portions of an optical system 100. The optical system 100 includes an object plane 102, a lens 104, a plurality of switching plates 106-110, and a sensor 112. In the example of a fingerprint scanner, the object plane 102 may represent a platen surface on which a finger makes contact. As described in further detail below, the desired object plane 102 location may move in relation to the other elements of the optical system 100, for example, based on whether the fingerprint scanner includes a silicone membrane at the time of use.

The lens 104 is placed between the object plane 102 and the sensor 112 to focus light beams from the object plane 102 on the sensor 112. The sensor 112 may be provided as an imaging/optical sensor, such as a two-dimensional (2D) CMOS sensor. The sensor 112 converts received light beams into electrical signals that form an image of the object in the object plane 102.

The lens 104 may be provided as a fixed-focus lens with an appropriate f-number. The space between the object plane 102 and the lens 104 is referred to as an object space.

The space between the lens 104 and the sensor 112 is referred to as an image space. The plurality of switching plates 106-110 are provided in the image space between the lens 104 and the sensor 112. The plurality of switching plates 106-110 can be provided as flat plates with different optical properties being made of glass, plastic or other suitably transmissive materials. For example, the plurality of switching plates 106-110 can each have a different thickness. Switching plate 106 has a thickness of L1; switching plate 108 has thickness of L2, and switching plate 110 has a thickness of L3, where L3<L2<L1. As another example, the plurality of switching plates 106-110 can have different refraction indexes. As a further example, the surface normal of the switching plates may be tilted by a fraction or a few degrees. In some cases, it may be beneficial to have a switching plate rotated with respect to the optical axis since rotation of a plate will affect the optical path length. Specifically, as one attempts to optimize focus at object planes further removed from the nominal design for a system that has a tilted object plane, the Scheimpflug angle or tilt of the sensor 112 can be changed. As dynamically tilting sensor 112 as a function of object plane distance may be problematic, a manner of at least partially compensating for the desired sensor tilt is to mount the corresponding switch plate slightly tilted since the refraction of the directed light from the lens 104 will result in an additional effective tilt to the image.

One or more of the switching plates 106-110 can be placed between the lens 104 and sensor 112 using a motor (not shown) based on the position of the object plane 102. The different optical properties of the switching plates 106-110 change the OPL of the optical system to achieve optimal focus of a given object plane 102 at the fixed location of the sensor 112. OPL can represent the length that light needs to travel through a vacuum to create the same phase difference as it would have when traveling through a given medium. In this example, the OPL of the imaging space can be represented as:

$${OPL\_IS}_{0} + {L}_{n} ( 1 / {RI}_{n} - 1 ) , \qquad ( 1 )$$

where OPL_IS₀ is the OPL of the image space with no plate inserted, and Lₙ and RIₙ are the thickness and refractive index, respectively, of the nth switching plate.

The difference in image space OPL between the cases of two different plates Lₙ and Lₘ (of the mth switching plate) inserted into the image space of the optical system's image space can therefore be represented as:

$$ΔOPL\_IS = {L}_{n} ( 1 / {RI}_{n} - 1 ) - {L}_{m} ( 1 / {RI}_{m} - 1 ) , \qquad ( 2 )$$

where Lₙ and RIₙ are the thickness and refractive index, respectively, of the nth switching plate and Lₘ and RIₘ are the thickness and refractive index, respectively, of the mth switching plate.

A shift in OPL of ΔOPL in image space corresponds to a shift in object space OPL represented as:

$$ΔOPL\_OS = {M}^{2} \cdot [ {L}_{n} ( 1 / {RI}_{n} - 1 ) - {L}_{m} ( 1 / {RI}_{m} - 1 ) ] , \qquad ( 3 )$$

where M is the longitudinal magnification of the optical system.

The switching plates 106-110 can be selectively placed in the optical path based on the location of the object plane 102. For example, the object plane 102 can represent a platen surface of a fingerprint scanner that can be operated with or without a silicone membrane. When a silicone membrane is not being used, the object plane 102 is closer to the sensor 112 as compared to when silicone membrane is being used.

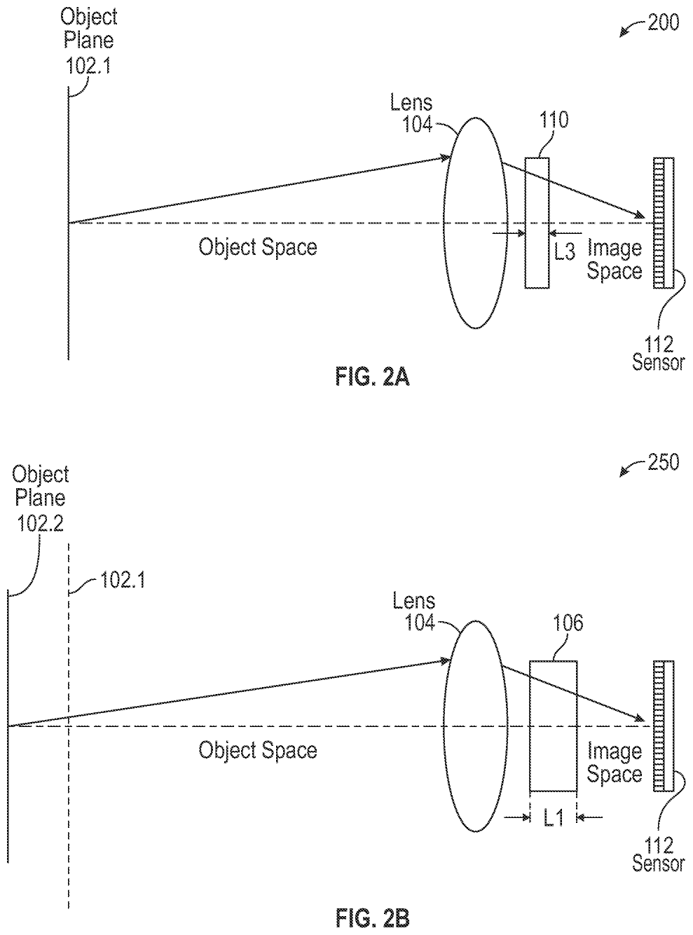

FIG. 2A illustrates example portions of the optical system 200 with an object plane at a first location. In this example, the object plane 102.1 may represent a location of the platen surface when a fingerprint scanner is being operated without a silicone membrane. In this example, switching plate 110 with thickness L3 can be used positioned in the image space of the optical system 100.

FIG. 2B illustrates example portions of the optical system 250 with an object plane at a second location. In this example, the object plane 102.2 may represent a location of the platen surface when a fingerprint scanner is being operated with a silicone membrane and hence further from imaging lens 104. In this example, switching plate 106 with thickness L1 can be used positioned in the image space of the optical system 100. Use of the thicker switching plate 106 (L1>L3), assuming plates 106 and 110 have the same index of refraction when the object plane 102.2 is further away adjusts the OPL of the optical system 100 such that a sharp image is still maintained at sensor 112 location in image space.

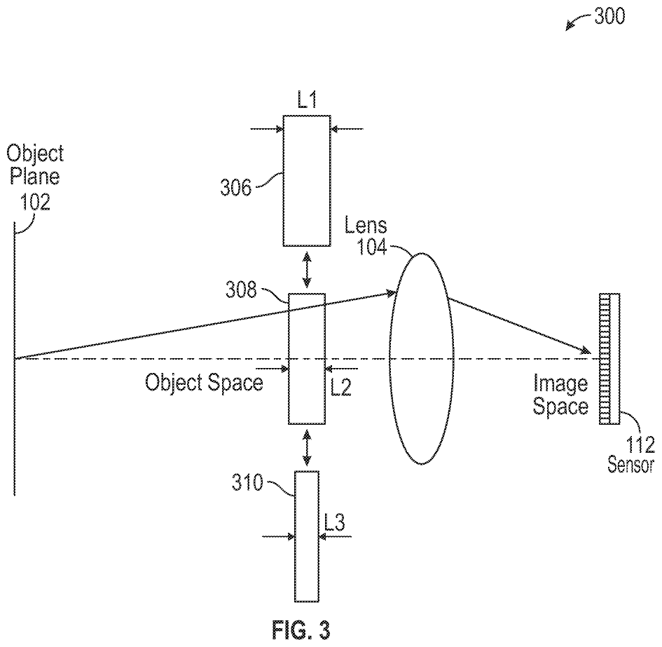

In some examples, the switching plates can be placed in the object space of the optical system. FIG. 3 illustrates example portions of an optical system 300. In optical system 300, one or more of the switching plates 306-310 can be switched or inserted into the object space of the optical system between object plane 102 and lens 104. In this case, the change in object space OPL when switching from a nth plate to an mth plate can be represented as:

$$ΔOPL\_OS = {L}_{n} ( 1 / R {I}_{n} - 1 ) - {L}_{m} ( 1 / R {I}_{m} - 1 ) . \qquad ( 4 )$$

Table 1 illustrates a few examples of how the object space OPL can be changed with the insertion of varying switching plates in different locations according to Eqs. (3) and (4).

TABLE 1

| | | Plate 1 | | Plate2 | | Magnification | ΔOPL [mm] |
|---|---|---|---|---|---|---|---|
| | Example | L1 [mm] | RI_1 | L2 [mm] | RI_2 | m | Obj. Space |
| Plates in | 1 | 1.00 | 1.50 | 1.10 | 1.50 | 10 | 3.33 |
| Image | 2 | 1.00 | 1.50 | 1.05 | 1.50 | 10 | 1.67 |
| Space | 3 | 1.00 | 1.50 | 1.00 | 1.60 | 10 | 4.17 |
| Plates in | 4 | 1.00 | 1.00 | 1.50 | 1.50 | 1 | 0.50 |
| Object | 5 | 1.00 | 1.50 | 1.50 | 1.50 | 1 | 0.17 |
| Space | 6 | 1.00 | 1.50 | 1.00 | 1.60 | 1 | 0.04 |

Examples 1-3 are for switching plates inserted in the image space of an optical system while Examples 4-6 are for switching plates inserted in the object space of the optical system. Examples 1 and 2 illustrate the change in object space OPL for the case of two different plates L1 and L2 made of the same material (same RI of 1.50), but with different thicknesses. These plates may be provided as two solid pieces of glass, plastic or other suitably transmissive materials, that are different thicknesses. Alternatively, the plates may be fabricated from the same material and with the same thickness, but a coating, for example, can be applied with a dip, spray, spin, meniscus or lamination process to some plates and in this manner tailor the final thickness of the plate. In Example 3, the two plates have the same thickness, but are fabricated from different materials and therefore have different indices of refraction.

In Examples 4-6, similar examples are illustrated where the plates are different thicknesses or different indices of refraction (example 4 illustrates the case were Plate 1 is just air with index of 1.00, i.e., no plate present). One notes that because of the magnification squared factor of Eq. (3), the change in object space OPL (right-hand column of Table 1), is significantly higher if the plates are placed in the image space of the system rather than in the object space portion of the system.

In some examples, two sets of switching plates may be included in the optical system with a first set being configured to be able to be inserted in the image space of the optical system (e.g., between lens 104 and sensor 112) and a second set being configured to be able to be inserted in the object space (e.g., between object plane 102 and lens 104).

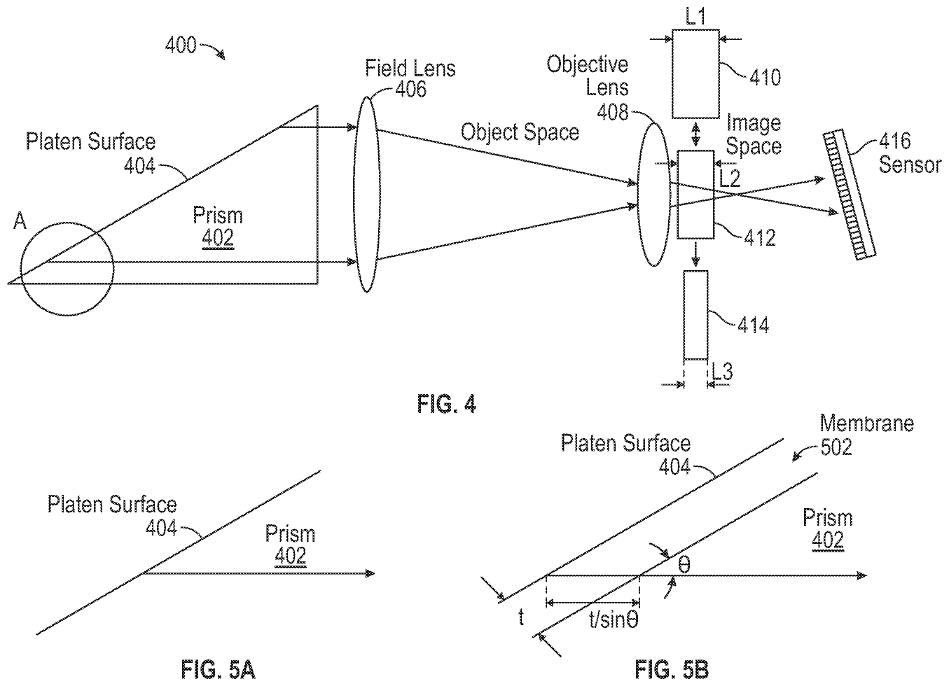

In a fingerprint sensor, the object plane may be provided as a platen surface of a prism to receive fingerprints. FIG. 4 illustrates example portions of an optical system 400 for a fingerprint scanner. The optical system 400 includes a prism 402. The prism 402 may be provided as a glass prism. The prism 402 may include a platen surface 404 to place a finger from which fingerprints are captured. The optical system includes a field lens 406, an objective lens 408, a plurality of switching plates 410-414, and a sensor 416. The sensor 416 may be provided as an imaging/optical sensor, such as a 2D CMOS sensor. The sensor 416 converts received light rays into electrical signals that form an image of fingerprints placed on the platen surface 404. The sensor 416 may be provided at a tilted angle (e.g., Scheimplug angle), which is a function of the angle of the platen surface 404 of the prism 402, the focal length of objective lens 408 and the magnification at which the system is operating.

The objective lens 408 may be provided as a fixed-focus lens with an appropriate f-number. The objective lens may include one or more elements of optical power that may comprise one or more of refractive, reflective and diffractive elements to achieve the appropriate imaging quality. The space between the field lens 406 and the tilted platen surface 404 is referred to as an object space.

The space between the objective lens 408 and the sensor 416 is referred to as an image space. The plurality of switching plates 410-414 are provided in the image space between the objective lens 408 and the sensor 416. The plurality of switching plates 410-414 can be provided as flat plates with different optical properties being made of glass, plastic or other suitably transmissive materials. For example, the plurality of switching plates 410-414 can each have a different thickness. Switching plate 410 has a thickness of L1; switching plate 412 has thickness of L2, and switching plate 414 has a thickness of L3, where L3<L2<L1. As another example, the plurality of switching plates 410-414 can have different refraction indexes. In some examples, the switching plates 410-414 may be provided at a tilted angle such as one to at least partially compensate for the ideal tilt angle of the sensor 416.

One or more of the switching plates 410-414 can be placed between the objective lens 408 and sensor 416 using a motor (not shown) based on the position of the platen surface 404. In some examples, the switching plates 410-414 can be placed in the object space between the field lens 406 and objective lens 408. When placing the switching plates in the object space, placing the switching plates close to objective lens 408 may provide additional benefits, such as minimizing the size of the plates. In some examples, two sets of switching plates may be included in the optical system with a first set being configured to be able to be inserted in the image space of the optical system and a second set being configured to be able to be inserted in the object space.

FIG. 5A illustrates a blowup of region A marked in FIG. 4 for the case where no membrane is placed on the prism 402, and FIG. 5B is a blowup of region A for the case where a membrane 502 of thickness/is placed on the prism 402. FIG. 5B illustrates the simple case for when the membrane 502 is comprised of a single material that has the same index of refraction as that of the prism 402 and therefore no refraction occurs at the prism-to-membrane interface. These simplification conditions are for illustration purposes and are not meant to be limiting or restrictive of the present disclosure. For the simplified case shown in FIG. 5B, the addition of the membrane increases the OPL in object space by:

$$ΔOPL\_OS \_membrane = t / ( {RI}_{s} \cdot sin θ ) \qquad ( 5 )$$

where RIₛ is the index of refraction the membrane. Therefore, for the design of a pair of switching plates to adjust focus when a membrane is present or not, then to first order, one requires that Eq. (5) is set equal to Eq. (3) or (4), depending upon whether or not the plates are to be placed in the image space or object space, respectively.

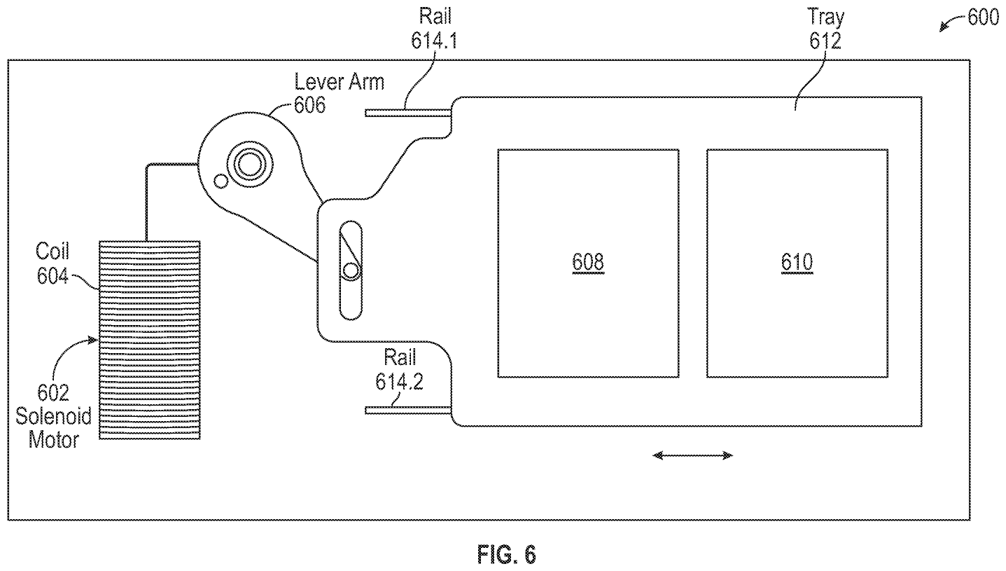

Different types of motors can be used to insert one or more of the switching plates in the optical path. In some examples, a solenoid motor can be used to move the switching plates. FIG. 6 illustrates example portions of a motor system 600. The motor system 600 includes a solenoid motor 602, a lever arm 606, a first switching plate 608, and a second switching plate 610.

The solenoid motor 602, through the use of a magnetic material, can trigger the lever arm 606 to move the first switching plate 608 and second switching plate 610. For example, the first switching plate 608 and the second switching plate 610 can be placed on a tray 612, which sits on rails 614.1, 614.2. The tray 612 with the switching plates 608, 610 can slide on the rails 614.1, 614.2 as actuated by the solenoid motor 602. The solenoid motor 602 may include a helical coil 604 wrapped around a cylindrical base. An electrical current can be passed through the helical coil 604 to generate a magnetic field. The higher the current, the stronger the magnetic field and the faster the switching speed. The magnetic field may act on a magnetic material mechanically coupled to lever arm 606, thereby driving the arm in one direction which sets an initial position of switching plates 608, 610 on tray 612. Reversing the current in coil 604 will reverse the magnetic field, reverse the force on lever arm 606, allowing the positions of the switching plates 608, 610 to switch back to their original state.

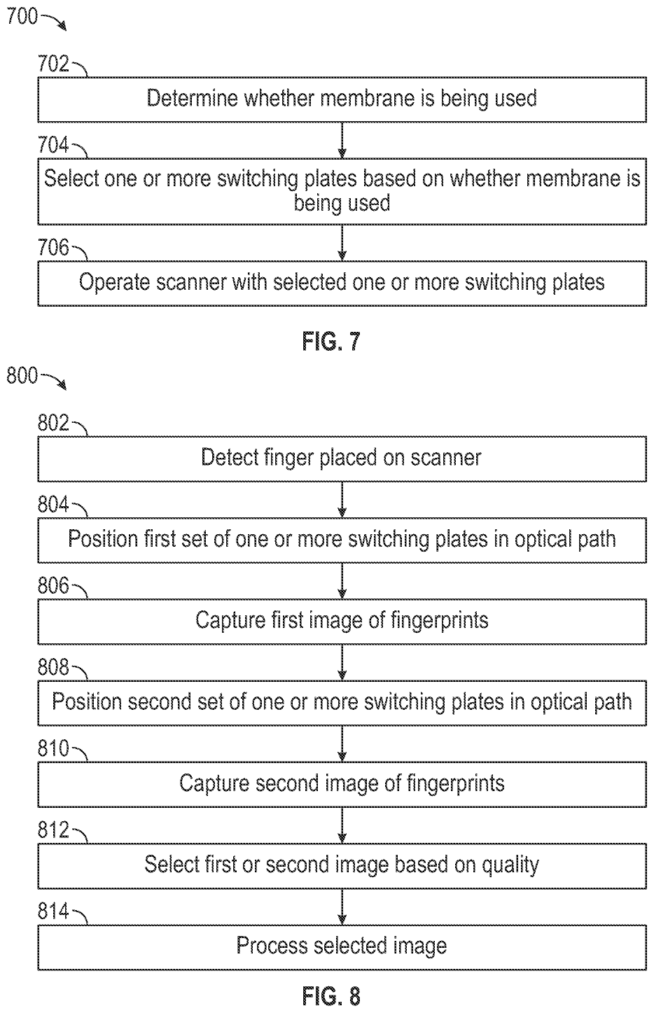

The placement of the switching plates in the optical systems described herein can be set at the time of configuration of the fingerprint scanner. FIG. 7 illustrates a flow diagram of a method 700 for system configuration for a fingerprint scanner. At operation 702, the scanner determines whether a membrane (e.g., silicone membrane) is placed on the platen surface to receive fingerprints. In some examples, a user interface (UI) screen may prompt a technician about whether a membrane is being used. In some examples, a sensor can be used to detect the presence of a membrane.

At operation 704, the scanner selects one or more switching plates with specified optical properties to be positioned in the optical path based on whether a membrane is being used. For example, if a membrane is being used, a thicker switching plate(s) may be selected as compared to the switching plate(s) selected when no membrane is present. The switching plates may be provided in the image space, object space, or both, as described herein. At operation 706, the scanner is operated using the selected one or more switching plates.

Although the flowchart of FIG. 7 illustrates an example method as comprising sequential steps or a process as having a particular order of operations, many of the steps or operations in the flowchart can be performed in parallel or concurrently, and the flowchart should be read in the context of the various embodiments of the present disclosure. The order of the method steps or process operations illustrated in FIG. 7 may be rearranged for some embodiments. Similarly, the method illustrated in FIG. 7 could have additional steps or operations not included therein or fewer steps or operations than those shown. For example, the system may not be told by an operator or have a sensor to detect if a membrane is present or not. In this case, operation 702 is skipped and system selects a switching plate, for example the last switching plate used to collect a fingerprint image. With the selected plate, the system may capture an image and if the image is of sufficient optical quality, the system may store that image for further processing. If this first analyzed image is not of sufficient quality, or the system requires a second imaging configuration image for comparison, the system may select a second plate, capture an image, analyze it for focus quality. The system may then compare the focus quality of the first and second analyzed image and make a determination regarding which image to keep for further processing. These steps may be repeated if the system has more than two switching plates.

In some situations, the fingerprint scanner may utilize different configurations of the switching plates to take multiple images of the same fingerprint. For example, thermal drift can sometimes significantly impact the optical elements to move the optical system out of focus. The effects of thermal drift can be difficult to approximate. FIG. 8 illustrates a flow diagram for a method 800 for operating a fingerprint scanner with insertable switching plates. At operation 802, the scanner may detect a finger being placed on the scanner. Such detection may occur through the use of a beam break or other separate finger detection sensor or finger detection may be provided using a software image analysis. For the latter, images continuously captured by sensor 112 may be analyzed to determine if objects with the correct shape, features, or quantity have touched the platen that would be indicative of the correct number of fingers or other particular requested area of skin topology is touching the platen. Examples of such image analysis methods are taught in U.S. Pat. Nos. 7,203,344 and 7,277,562 which are incorporated herein by reference.

At operation 804, the scanner may select a first set of one or more switching plates to position in the optical path as described herein. The first set of one or more switching plates may provide a first OPL. At operation 806, the scanner may take a first image of the fingerprint placed on the scanner using the first set of one or more switching plates.

At operation 808, the scanner may select a second set of one or more switching plates to position in the optical path as described herein. The second set of one or more switching plates may provide a second OPL. At operation 810, the scanner may take a second image of the fingerprint placed on the scanner using the second set of one or more switching plates. At operation 812, the scanner (e.g., processor therein) selects the first image or second image based on focus quality. At operation 814, the scanner processes the selected image, such as to perform a comparison of the captured fingerprints to stored fingerprint profiles.

Although the flowchart of FIG. 8 illustrates an example method as comprising sequential steps or a process as having a particular order of operations, many of the steps or operations in the flowchart can be performed in parallel or concurrently, and the flowchart should be read in the context of the various embodiments of the present disclosure. The order of the method steps or process operations illustrated in FIG. 8 may be rearranged for some embodiments. Similarly, the method illustrated in FIG. 8 could have additional steps or operations not included therein or fewer steps or operations than those shown.

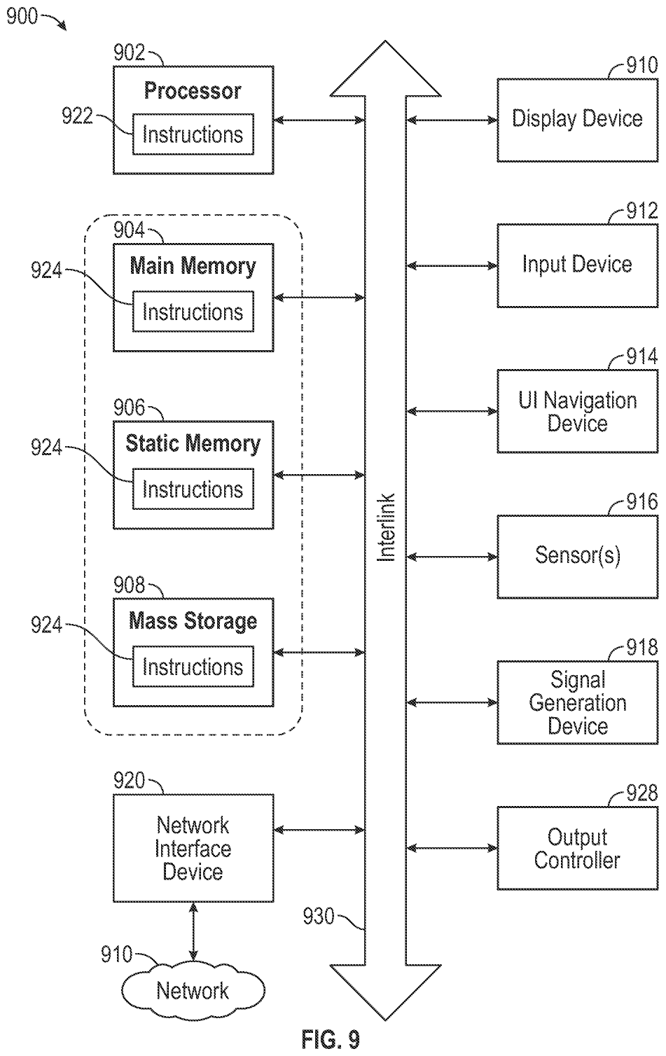

FIG. 9 illustrates a block diagram schematic of various example components of an example machine 900 that can be used as, for example, a fingerprint scanning system. Examples, as described herein, can include, or can operate by, logic or a number of components, modules, or mechanisms in machine 900. Modules may be hardware, software, or firmware communicatively coupled to one or more processors in order to carry out the operations described herein. Generally, circuitry (e.g., processing circuitry) is a collection of circuits implemented in tangible entities of machine 900 that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional and/or more specific examples of components with respect to machine 900 follow.

In some embodiments, machine 900 can operate as a standalone device or can be connected (e.g., networked) to other machines. In a networked deployment, machine 900 can operate in the capacity of a server machine, a client machine, or both in server-client network environments. In some examples, machine 900 can act as a peer machine in a peer-to-peer (P2P) (or other distributed) network environment. Machine 900 can be or include a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 900 can include a hardware processor 902 (e.g., a central processing unit (CPU), a graphics processing unit (GPU), a hardware processor core, or any combination thereof) and a main memory 904, a static memory (e.g., memory or storage for firmware, microcode, a basic-input-output (BIOS), unified extensible firmware interface (UEFI), etc.) 906, and/or mass storage 908 (e.g., hard drives, tape drives, flash storage, or other block devices) some or all of which can communicate with each other via an interlink (e.g., bus) 930. Machine 900 can further include a display device 910 and an input device 912 and/or a user interface (UI) navigation device 914. Example input devices and UI navigation devices include, without limitation, one or more buttons, a keyboard, a touch-sensitive surface, a stylus, a camera, a microphone, etc.). In some examples, one or more of the display device 910, input device 912, and UI navigation device 914 can be a combined unit, such as a touch screen display. Machine 900 can additionally include a signal generation device 918 (e.g., a speaker), a network interface device 920, and one or more sensors 916, such as a global positioning system (GPS) sensor, compass, accelerometer, or other sensor. Machine 900 can include an output controller 928, such as a serial (e.g., universal serial bus (USB), parallel, or other wired or wireless (e.g., infrared (IR), NFC, etc.) connection to communicate or control one or more peripheral devices (e.g., a printer, card reader, etc.).

Processor 902 can correspond to one or more computer processing devices or resources. For instance, processor 902 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 902 can be provided as a microprocessor, Central Processing Unit (CPU), or plurality of microprocessors or CPUs that are configured to execute instructions sets stored in an internal memory 922 and/or memory 904, 906, 908.

Any of memory 904, 906, and 908 can be used in connection with the execution of application programming or instructions by processor 902 for performing any of the functionality or methods described herein, and for the temporary or long-term storage of program instructions or instruction sets 924 and/or other data for performing any of the functionality or methods described herein. Any of memory 904, 906, 908 can comprise a computer readable medium that can be any medium that can contain, store, communicate, or transport data, program code, or instructions 924 for use by or in connection with machine 900. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. As noted above, computer-readable media includes, but is not to be confused with, computer-readable storage medium, which is intended to cover all physical, non-transitory, or similar embodiments of computer-readable media.

Network interface device 920 includes hardware to facilitate communications with other devices over a communication network, such as the one or more networks described above, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 920 can include an Ethernet port or other physical jack, a Wi-Fi card, a Network Interface Card (NIC), a cellular interface (e.g., antenna, filters, and associated circuitry), or the like. In some examples, network interface device 920 can include one or more antennas to wirelessly communicate using at least one of single-input multiple-output (SIMO), multiple-input multiple-output (MIMO), or multiple-input single-output (MISO) techniques.

### ADDITIONAL EXAMPLES

Example 1 includes subject matter relating to an optical system comprising: an object plane to receive an object to be imaged; a lens to direct light beams from the object plane; a sensor to convert the directed light beams into an image; and a plurality of switching plates being configured to be selectively inserted into an optical path between the object plane and the sensor defining different optical path lengths to account for changes in a location of the object plane.

In Example 2, the subject matter of Example 1, wherein the plurality of switching plates include flat optical elements having different optical properties.

In Example 3, the subject matter of Example 2, wherein the optical properties include thicknesses of the plurality of switching plates.

In Example 4, the subject matter of any of Examples 1 to 3, wherein the optical system is included in a fingerprint scanner and the object is a finger.

In Example 5, the subject matter of any of Examples 1 to 4, wherein the plurality of switching plates are positioned in an image space of the optical system between the lens and the sensor.

In Example 6, the subject matter of any of Examples 1 to 5, wherein the plurality of switching plates are positioned in an object space of the optical system between the object plane and the lens.

In Example 7, the subject matter of any of Examples 1 to 6, wherein the plurality of switching plates include a first set of switching plates positioned in an image space of the optical system between the lens and the sensor and second set of switching plates positioned in an object space of the optical system between the object plane and the lens.

In Example 8, the subject matter of any of Examples 1 to 7, wherein the object plane is defined by a platen surface of a prism to receive the object in a first configuration and is defined by a membrane on the platen surface of the prism to receive the object in a second configuration.

In Example 9, the subject matter of any of Examples 1 to 8, further comprising: a solenoid motor to move the plurality of switching plates.

Example 10 includes subject matter relating to a skin topology scanning system comprising: a platen surface to receive at least one object having a skin topology; a lens to focus direct light beams from the platen surface; a sensor to convert the focused directed light beams into an image of the at least one object; and a plurality of switching plates being configured to be selectively inserted into an optical path between the platen surface and the sensor defining different optical path lengths to account for shifts in a location of the platen surface.

In Example 11, the subject matter of Example 10, wherein in a first configuration, the platen surface is a top surface of a prism, and wherein in a second configuration, the platen surface is a membrane surface on the top surface of the prism.

In Example 12, the subject matter of any of Examples 10 to 11, wherein the plurality of switching plates include flat optical elements having different optical properties.

In Example 13, the subject matter of Example 12, wherein the optical properties include thicknesses of the plurality of switching plates.

In Example 14, the subject matter of any of Examples 10 to 13, wherein the skin topology scanning system is a fingerprint scanner and the at least one object is a finger.

In Example 15, the subject matter of any of Examples 10 to 14, wherein the plurality of switching plates are positioned in an image space between the lens and the sensor.

In Example 16, the subject matter of any of Examples 10 to 15, wherein the plurality of switching plates are positioned in an object space between the platen surface and the lens.

In Example 17, the subject matter of any of Examples 10 to 16, wherein the plurality of switching plates include a first set of switching plates positioned in an image space between the lens and the sensor and second set of switching plates positioned in an object space between the platen surface and the lens.

In Example 18, the subject matter of any of Examples 10 to 17, further comprising: a solenoid motor to move the plurality of switching plates.

Example 19 includes subject matter relating to a method comprising: detecting an object having a skin topology being placed on a surface of a skin topology scanner; positioning a first switching plate of a plurality of switching plates in an optical path of the fingerprint scanner defining a first optical path length; capturing a first image of the skin topology of the object with the first optical path length; positioning a second switching plate of the plurality of switching plates in the optical path of the skin topology scanner defining a second optical path length; capturing a second image of the skin topology of the object with the second optical path; selecting the first image or the second image based on focus quality; and processing the selected image.

In Example 20, the subject matter of Example 19, wherein the first switching plate is provided in an image space of the skin topology scanner.

### ADDITIONAL NOTES

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. As indicated above, the computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), a compact disc read-only memory (CD-ROM), or other optical, magnetic, or solid state storage device. As noted above, computer-readable media includes, but is not to be confused with, computer-readable storage medium, which is intended to cover all physical, non-transitory, or similar embodiments of computer-readable media.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. An optical system comprising:
an object plane to receive an object to be imaged;
a lens to direct light beams from the object plane;
a sensor to convert the directed light beams into an image; and
a plurality of switching plates being configured to be selectively inserted into an optical path between the object plane and the sensor defining different optical path lengths to account for changes in a location of the object plane.

2. The optical system of claim 1, wherein the plurality of switching plates include flat optical elements having different optical properties.

3. The optical system of claim 2, wherein the optical properties include thicknesses of the plurality of switching plates.

4. The optical system of claim 1, wherein the optical system is included in a fingerprint scanner and the object is a finger.

5. The optical system of claim 1, wherein the plurality of switching plates are positioned in an image space of the optical system between the lens and the sensor.

6. The optical system of claim 1, wherein the plurality of switching plates are positioned in an object space of the optical system between the object plane and the lens.

7. The optical system of claim 1, wherein the plurality of switching plates include a first set of switching plates positioned in an image space of the optical system between the lens and the sensor and second set of switching plates positioned in an object space of the optical system between the object plane and the lens.

8. The optical system of claim 1, wherein the object plane is defined by a platen surface of a prism to receive the object in a first configuration and is defined by a membrane on the platen surface of the prism to receive the object in a second configuration.

9. The optical system of claim 1, further comprising:
a solenoid motor to move the plurality of switching plates.

10. A skin topology scanning system comprising:
a platen surface to receive at least one object having a skin topology;
a lens to direct light beams from the platen surface;
a sensor to convert the directed light beams into an image of the at least one object; and
a plurality of switching plates being configured to be selectively inserted into an optical path between the platen surface and the sensor defining different optical path lengths to account for shifts in a location of the platen surface.

11. The skin topology scanning system of claim 10, wherein in a first configuration, the platen surface is a top surface of a prism, and wherein in a second configuration, the platen surface is a membrane surface on the top surface of the prism.

12. The skin topology scanning system of claim 10, wherein the plurality of switching plates include flat optical elements having different optical properties.

13. The skin topology scanning system of claim 12, wherein the optical properties include thicknesses of the plurality of switching plates.

14. The skin topology scanning system of claim 10, wherein the skin topology scanning system is a fingerprint scanner and the at least one object is a finger.

15. The skin topology scanning system of claim 10, wherein the plurality of switching plates are positioned in an image space between the lens and the sensor.

16. The skin topology scanning system of claim 10, wherein the plurality of switching plates are positioned in an object space between the platen surface and the lens.

17. The skin topology scanning system of claim 10, wherein the plurality of switching plates include a first set of switching plates positioned in an image space between the lens and the sensor and second set of switching plates positioned in an object space between the platen surface and the lens.

18. The skin topology scanning system of claim 10, further comprising:
a solenoid motor to move the plurality of switching plates.

19. A method comprising:
detecting an object having a skin topology being placed on a surface of a skin topology scanner;
positioning a first switching plate of a plurality of switching plates in an optical path of the fingerprint scanner defining a first optical path length;
capturing a first image of the skin topology of the object with the first optical path length;
positioning a second switching plate of the plurality of switching plates in the optical path of the skin topology scanner defining a second optical path length;
capturing a second image of the skin topology of the object with the second optical path;
selecting the first image or the second image based on focus quality; and
processing the selected image.

20. The method of claim 19, wherein the first switching plate is provided in an image space of the skin topology scanner.
